(19) United States
(12) Patent Application Publication
(10) Pub. No.: US 2021/0326528 A1
(43) Pub. Date: Oct. 21, 2021

(54) LANGUAGE ANALYSIS PLATFORM BASED ON TARGET RECIPIENT PROFILE DATA

(71) Applicant: salesforce.com, inc., San Francisco, CA (US)

(72) Inventors: Christopher Anthony Kemp, Toronto (CA); Daniel Thomas Harrison, Newmarket, CA (US)

(21) Appl. No.: 16/849,345

(22) Filed: Apr. 15, 2020

(51) Int. Cl. G06F 40/253; G06F 40/35; G06F 40/166; H04L 29/08

(52) U.S. Cl. CPC G06F 40/253; H04L 67/306; G06F 40/166; G06F 40/35

(57) ABSTRACT

System and methods are described for performing message language analysis based on target recipient profile data. In one implementation, a method comprises receiving proposed content to be transmitted to a target recipient; computing one or more semantic factors descriptive of the proposed content; comparing the one or more semantic factors with data stored in a profile associated with the target recipient; and generating, based on the comparison, one or more recommended edits to the proposed content to customize the proposed content to the target recipient.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

One or more implementations relate to natural language processing, and, more specifically, to language analysis platforms for generating content edit recommendations.

### BACKGROUND

Matching tone and style to audience preferences is of great importance during marketing, sales, and service activities to increase positive responses from recipients, which can be measured, for example, by email click-through events, lead generation, purchases of goods or services by the recipients, and customer experience metrics. While artificial intelligence (AI)-based approaches are able to successfully translate messages into other languages, such systems lack the ability to optimize tone, complexity, and other semantic factors in a way that leads to increased positive responses from recipients.

### BRIEF DESCRIPTION OF THE DRAWINGS

The included drawings are for illustrative purposes and serve to provide examples of possible structures and operations for the disclosed inventive systems, apparatus, methods, and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a system diagram of example architectural components of an on-demand database service environment according to some implementations.

FIG. 2B shows a system diagram further illustrating example architectural components of an on-demand database service environment according to some implementations.

FIG. 3 illustrates a diagrammatic representation of a machine in the exemplary form of a computer system within which one or more implementations may be carried out.

FIG. 4 shows a block diagram illustrating the components of a language alignment engine according to some implementations.

FIG. 5 is a data flow model illustrating the functionality of a language alignment engine according to some implementations.

FIG. 6 is a flow diagram illustrating an exemplary method for performing message language analysis based on target recipient profile data according to some implementations.

### DETAILED DESCRIPTION

The implementations described herein relate to a language analysis platform that utilizes target recipient profile data to generate content, edit content, or generate recommended edits to content. Certain implementations relate to a system that predicts and suggests language for messages to be sent to individuals, groups of individuals, or an audience to improve the probability that the intended message aligns with the target recipient. Initially, a message may be written (e.g., by marketing personnel) for the purpose of being sent to a target recipient. The system evaluates one or more semantic factors of the message and compares it with known preferences of the recipient. The system further provides feedback on how to adjust the message based on target recipient preferences. When the recipient preferences are unknown or there is limited information, the system may utilize baseline assumptions about a group having similar characteristics of the target recipient, and aggregate feedback (e.g., based on click-through events, tone of customer responses, etc.) from the recipient to determine the recipient's preferences.

The implementations described herein allow for large-scale artificial intelligence (AI)-based language alignment to improve engagement with recipients (e.g., customers) using language processing algorithms to compare intended or target messages with historical interactions (e.g., using A-B testing). In current customer relationship management systems, a typical marketing message may be written in with specific tone, style, and language, but is the same message for all recipients or uses simplistic marketing segmentation tailored to one segment. The recipient often discards these templated emails without opening or reading them. In contrast, the implementations described herein allow for the generation of outbound messages that can be tailored to each recipient's preference of tone, style, complexity, or other semantic factors. As bulk emails are sent to recipients, the system may match the open rate or click-through events for the message to the recipients' profiles to improve the engagement by matching the tone, style, etc. of future messages to these results. This approach may be adapted for other 1:1 channels, such as marketing via text messages or automated messages (e.g., chatbot messages).

In some implementations, when an outbound message is to be sent via, email, chat, marketing campaign, chatbot, etc., the message will be passed in real time to a language alignment engine. The language alignment engine will retrieve historical interactions for that specific recipient and the recipient's profile, and then match the type of message and recipient profile to historical interaction with an A-B test history (e.g., determinations of what type of messages work for which profiles). A new message may be generated utilizing AI-based natural language processing that reflects the recipient's preferred style, complexity, etc. This new message could be validated by the human sender prior to sending or sent out to the recipient automatically with no human review (e.g., as would generally be the case for a chatbot application). This approach ultimately results in better communication with the target recipient by including appropriate terms and vernacular, as well as avoiding language that is potentially insulting or culturally insensitive.

In practice, some recipients prefer to receive communications or messaging in very technical and complex language (e.g. software developers, professionals, academics, etc.), while others prefer simpler, non-technical terms. When profile data is lacking for a particular target recipient, the system may start with an assumed educational level for the language used (e.g., typically Grade 8 for English communications) or an expected technical competency (e.g., typically no technical knowledge is assumed). When profile data has been obtained for a target recipient or audience, messaging may be selected that aligns with the target recipient or audience preferences for language grade or technical competency. Previous e-mails and messages and their response rates can be analyzed and used to build a baseline, for example, using A-B testing. In certain implementations, the A-B results may be used in a feedback algorithm to aid in the training of a language analysis model for the system.

Certain implementations may be utilized by sales personnel when generating outbound emails to help ensure that it matches the style of the specific email. This is important particularly when the message is in response to medical professionals and non-technical individuals associated with the same entity. Receiving the drafted email as input, the system would identify the profile(s) of the recipient(s) to validate the lowest common denominator for various semantic factors, such as technical complexity, medical complexity, language grade, or style (e.g., business versus social), and then warn the sender of any mismatch, generate recommendations, flag for review by a manager, automate the improvements, or some combination thereof.

Certain implementations may be utilized by marketing personnel to perform natural language processing (NLP) analysis on previous email correspondence to build a profile on the recipient (e.g., customer). This can be performed, for example, by analyzing the style of previous marketing emails using NLP analysis to determine tone (e.g. direct, empathetic, humorous) and/or other semantic factors, and determining which category elicits the most positive response (e.g., by analyzing open rates, click-through events, or purchases) for that particular recipient. Marketing personnel can then produce a number of variants of the marketing copy, each tailored to one of those specific groups that respond best, increasing their intended results for their total audience.

Certain implementations may be utilized by service professionals to improve their responses to customers to best fit their technical level and understanding, as well as their preferred tone. For example, if a service professional is helping a customer repair a piece of equipment, it is possible that the customer was unable to understand previously used technical terms. The system may identify responses from the customer (e.g., “I don't understand”) that may be used to identify technical terms that are causing confusion, and generate proposed content edits to reduce the technical complexity. This will improve time to resolution, freeing up customer service representatives to help others. The system may account for appropriate content tone during different times of the resolution cycle. For example, if a customer has a problem, providing humorous content at the start of the interaction is unlikely to elicit a positive response because the customer is likely to be angry as a result of having encountered the problem.

Certain implementations may be utilized in connection with automated messaging systems (e.g., chatbot applications). Chatbots are often used to provide pre-defined responses to recipients (e.g., customers) that align with corporate messaging strategies. However, these applications do not take into account the recipient's language style preferences. In the implementations described herein, a chatbot would account for the preferences of the individual making a chat inquiry and begin the conversation with messaging that aligns with the recipient's preferences. When a question is posed, the pre-defined response would be processed to generate a custom response based on, for example, the recipient's semantic factor preferences or historical responses that were determined to elicit the most successful responses from other similar customers (e.g., customers having demographic or educational similarities).

The implementations described herein improve upon traditional sentiment systems because such systems neither compare tone of a potential message to customer profiles nor generate profile groupings based on how customers have historically responded to similar messages. For example, while current systems perform basic sentiment and emotional analysis, such systems do not make any suggestions on how to fix or edit tone, nor do they account for language complexity (e.g., too much technical jargon). Moreover, such systems do not attempt to match the tone of a message with the preferences of the target recipients, nor do they incorporate any feedback to predict preferences for messages targeted to individual users or provided as mass communications.

The implementations described herein address these and other limitations of current systems by deriving semantic factors derived from proposed content, and comparing the semantic factors to profile data of a target recipient to generate recommended edits to the proposed content. Further advantages of the implementations of the disclosure over current systems include, but are not limited to: (1) customizing content to individual recipients or groups of recipients at the individual level without requiring a content developer to manually produce multiple variants of the content; (2) the ability to track responses of recipients after proposed content has been sent to and received by the recipients, and update historical profile data based on the responses; (3) dynamic generation of group profiles that match multiple semantic factors (e.g., tone, style, grade, etc.) based on individual profiles, historical interactions, and predicted success rates.

As used herein, “proposed content” refers to a message written by, for example, an individual (e.g., marketing personnel) or derived from the same to be evaluated prior to sending to a target recipient, group of recipients, or audience (e.g., an email blast).

Also as used herein, “semantic factors” refers to any metric derived from content that is descriptive of the content, such as, but not limited to, metrics describing tone, style, complexity, language grade level, or sentiment.

Also as used herein a “profile” (e.g., of a target recipient of content) refers to any data compiled on an individual or group of individuals descriptive of the messaging preferences, demographic information, geographic information, educational level, profession, or other data descriptive of the individual or group of individuals.

Examples of systems, apparatuses, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B, or C” is intended to include the possibilities of “A,” “B,” “C,” “A and B,” “B and C,” “A and C,” and “A, B, and C.”

The words “example” or “exemplary” are used herein to mean serving as an example, instance, or illustration. Any aspect or design described herein as an “example” or “exemplary” is not necessarily to be construed as preferred or advantageous over other aspects or designs. Rather, use of the words “example” or “exemplary” is intended to present concepts in a concrete fashion.

In addition, the articles “a” and “an” as used herein and in the appended claims should generally be construed to mean “one or more” unless specified otherwise or clear from context to be directed to a singular form. Reference throughout this specification to “an implementation,” “one implementation,” “some implementations,” or “certain implementations” indicates that a particular feature, structure, or characteristic described in connection with the implementation is included in at least one implementation. Thus, the appearances of the phrase “an implementation,” “one implementation,” “some implementations,” or “certain implementations” in various locations throughout this specification are not necessarily all referring to the same implementation.

Some portions of the detailed description may be presented in terms of algorithms and symbolic representations of operations on data bits within a computer memory. These algorithmic descriptions and representations are the manner used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “retrieving,” “transmitting,” “computing,” “generating,” “processing,” “reprocessing,” “adding,” “subtracting,” “multiplying,” “dividing,” “optimizing,” “calibrating,” “detecting,” “performing,” “analyzing,” “determining,” “enabling,” “identifying,” “modifying,” “transforming,” “applying,” “aggregating,” “extracting,” “registering,” “querying,” “populating,” “hydrating,” “updating,” “mapping,” “causing,” “storing,” “prioritizing,” “queuing,” “managing,” “comparing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission, or display devices.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM, and the like without departing from the scope of the implementations claimed. Moreover, the implementations are applicable to other systems and environments including, but not limited to, client-server models, mobile technology and devices, wearable devices, and on-demand services.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Any of the software components or functions described in this application can be implemented as software code to be executed by one or more processors using any suitable computer language such as, for example, C, C++, Java™ (which is a trademark of Sun Microsystems, Inc.), or Perl using, for example, existing or object-oriented techniques. The software code can be stored as non-transitory instructions on any type of tangible computer-readable storage medium (referred to herein as a “non-transitory computer-readable storage medium”). Examples of suitable media include random access memory (RAM), read-only memory (ROM), magnetic media such as a hard-drive or a floppy disk, or an optical medium such as a compact disc (CD) or digital versatile disc (DVD), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

The disclosure also relates to apparatuses, devices, and system adapted/configured to perform the operations herein. The apparatuses, devices, and systems may be specially constructed for their required purposes, may be selectively activated or reconfigured by a computer program, or some combination thereof.

### EXAMPLE SYSTEM OVERVIEW

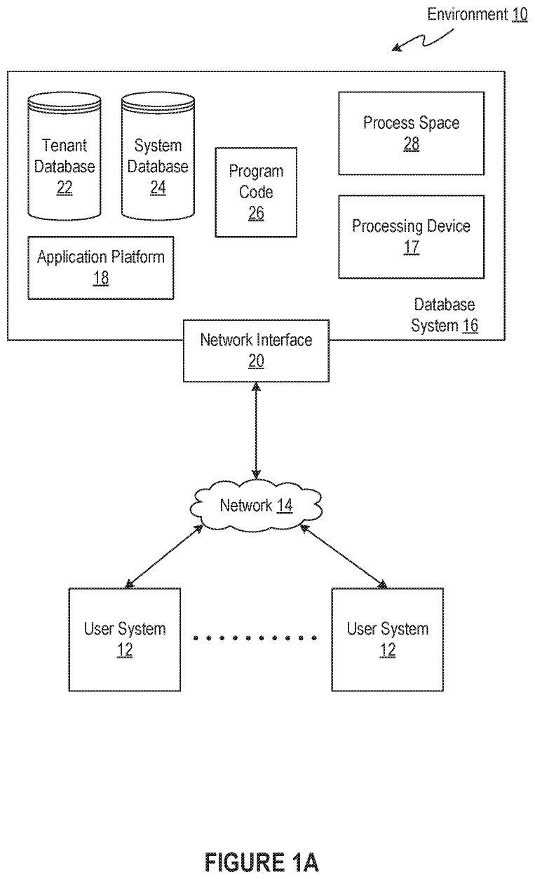

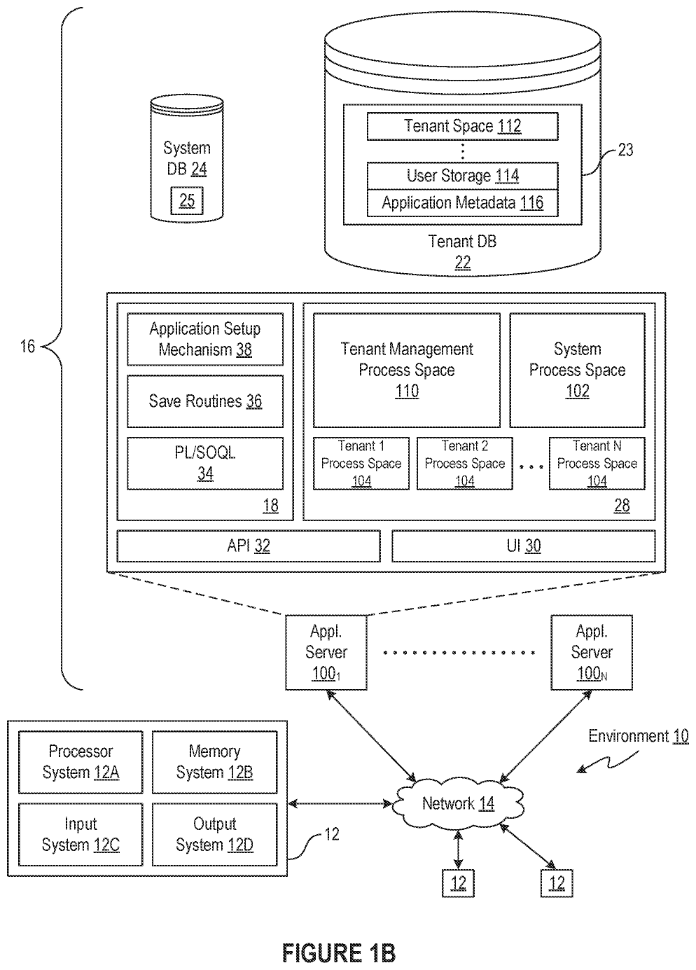

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the database system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the database system 16, is a service that is made available to users outside an enterprise (or enterprises) that owns, maintains, or provides access to the database system 16. An “enterprise” refers generally to a company or organization that owns one or more data centers that host various services and data sources. A “data center” refers generally to a physical location of various servers, machines, and network components utilized by an enterprise.

As described above, such users generally do not need to be concerned with building or maintaining the database system 16. Instead, resources provided by the database system 16 may be available for such users' use when the users need services provided by the database system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of the database system 16 to execute, such as the hardware or software infrastructure of the database system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the database system 16 implements a web-based customer relationship management (CRM) system. For example, in some such implementations, the database system 16 includes application servers configured to implement and execute CRM software applications as well as provide related data, code, forms, renderable web pages, and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The database system 16 also implements applications other than, or in addition to, a CRM application. For example, the database system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the database system 16.

According to some implementations, each database system 16 is configured to provide web pages, forms, applications, data, and media content to user (client) systems 12 to support the access by user systems 12 as tenants of the database system 16. As such, the database system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application, such as an object-oriented database management system (OODBMS) or a relational database management system (RDBMS), as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a local area network (LAN), wide area network (WAN), telephone network, wireless network, cellular network, point-to-point network, star network, token ring network, hub network, or other appropriate configuration. The network 14 can include a Transfer Control Protocol and Internet Protocol (TCP/IP) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with the database system 16 using TCP/IP and, at a higher network level, other common Internet protocols to communicate, such as the Hyper Text Transfer Protocol (HTTP), Hyper Text Transfer Protocol Secure (HTTPS), File Transfer Protocol (FTP), Apple File Service (AFS), Wireless Application Protocol (WAP), etc. In an example where HTTP is used, each user system 12 can include an HTTP client commonly referred to as a “web browser” or simply a “browser” for sending and receiving HTTP signals to and from an HTTP server of the database system 16. Such an HTTP server can be implemented as the sole network interface 20 between the database system 16 and the network 14, but other techniques can be used in addition to or instead of these techniques. In some implementations, the network interface 20 between the database system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, WAP-enabled device, or other computing device capable of interfacing directly or indirectly to the Internet or other network. When discussed in the context of a user, the terms “user system,” “user device,” and “user computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, personal digital assistant (PDA), or other wireless device, allowing a user (for example, a subscriber of on-demand services provided by the database system 16) of the user system 12 to access, process, and view information, pages, and applications available to it from the database system 16 over the network 14.

Each user system 12 also typically includes one or more user input devices, such as a keyboard, a mouse, a trackball, a touch pad, a touch screen, a pen or stylus, or the like, for interacting with a GUI provided by the browser on a display (for example, a monitor screen, liquid crystal display (LCD), light-emitting diode (LED) display, etc.) of the user system 12 in conjunction with pages, forms, applications, and other information provided by the database system 16 or other systems or servers. For example, the user interface device can be used to access data and applications hosted by database system 16, and to perform searches on stored data, or otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the database system 16, that user system can have the capacities allotted to the salesperson. However, while an administrator is using that user system 12 to interact with the database system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU), such as an Intel Pentium® processor or the like. Similarly, the database system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The database system 16 includes non-transitory computer-readable storage media having instructions stored thereon that are executable by or used to program a server or other computing system (or collection of such servers or computing systems) to perform some of the implementation of processes described herein. For example, the program code 26 can include instructions for operating and configuring the database system 16 to intercommunicate and to process web pages, applications, and other data and media content as described herein. In some implementations, the program code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, DVDs, CDs, microdrives, magneto-optical discs, magnetic or optical cards, nanosystems (including molecular memory integrated circuits), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™ JavaScript, ActiveX, any other scripting language, such as VBScript, and many other programming languages as are well known.

FIG. 1B shows a block diagram of example implementations of elements of FIG. 1A and example interconnections between these elements according to some implementations. That is, FIG. 1B also illustrates environment 10, but FIG. 1B, various elements of the database system 16 and various interconnections between such elements are shown with more specificity according to some more specific implementations. In some implementations, the database system 16 may not have the same elements as those described herein or may have other elements instead of, or in addition to, those described herein.

In FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 100₁-100_{N}. Each application server 100, also referred to herein as an “app server,” is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114, and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The database system 16 also includes a user interface (UI) 30 and an application programming interface (API) 32. The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process space 110, for example. Invocations to such applications can be coded using PL/SOQL 34, which provides a programming language style interface extension to the API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, issued on Jun. 1, 2010, and hereby incorporated by reference herein in its entirety and for all purposes. Invocations to applications can be detected by one or more system processes, which manage retrieving application metadata 116 for the subscriber making the invocation and executing the metadata as an application in a virtual machine.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100₂ can be coupled via a direct network link, and another application server 100_{N} can be coupled by yet a different network connection. Transfer Control Protocol and Internet Protocol (TCP/IP) are examples of typical protocols that can be used for communicating between application servers 100 and the database system 16. However, it will be apparent to one skilled in the art that other transport protocols can be used to optimize the database system 16 depending on the network interconnections used.

In some implementations, each application server 100 is configured to handle requests for any user associated with any organization that is a tenant of the database system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, database system 16 can be a multi-tenant system in which database system 16 handles storage of, and access to, different objects, data, and applications across disparate users and organizations.

In one example storage use case, one tenant can be a company that employs a sales force where each salesperson uses database system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by database system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the database system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the database system 16. Such requests and updates can involve sending one or more queries to tenant database 22 or system database 24. The database system 16 (for example, an application server 100 in the database system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, issued on Aug. 17, 2010, and hereby incorporated by reference herein in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

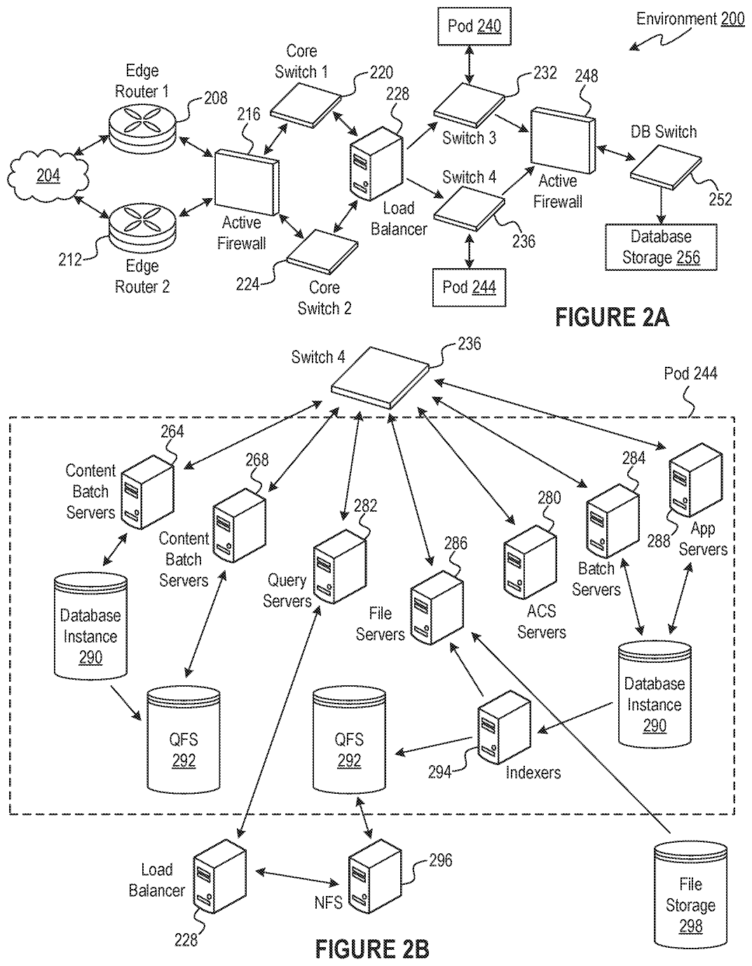

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. The pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to several devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server,” “device,” and “processing device” as used herein are not limited to a single hardware device; rather, references to these terms can include any suitable combination of hardware and software configured to provide the described functionality.

The cloud 204 is intended to refer to a data network or multiple data networks, often including the Internet. Client machines communicably connected with the cloud 204 can communicate with other components of the on-demand database service environment 200 to access services provided by the on-demand database service environment. For example, client machines can access the on-demand database service environment to retrieve, store, edit, or process information. In some implementations, the edge routers 208 and 212 route packets between the cloud 204 and other components of the on-demand database service environment 200. For example, the edge routers 208 and 212 can employ the Border Gateway Protocol (BGP). The BGP is the core routing protocol of the Internet. The edge routers 208 and 212 can maintain a table of Internet Protocol (IP) networks or ‘prefixes,’ which designate network reachability among autonomous systems on the Internet.

In some implementations, the firewall 216 can protect the inner components of the on-demand database service environment 200 from Internet traffic. The firewall 216 can block, permit, or deny access to the inner components of the on-demand database service environment 200 based upon a set of rules and other criteria. The firewall 216 can act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 can be configured as network bridges that quickly route data between different components within the on-demand database service environment. In some implementations, the use of two or more core switches 220 and 224 can provide redundancy or reduced latency.

In some implementations, the pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between the pods 240 and 244 is conducted via the pod switches 232 and 236. The pod switches 232 and 236 can facilitate communication between the pods 240 and 244 and client machines communicably connected with the cloud 204, for example, via core switches 220 and 224. Also, the pod switches 232 and 236 may facilitate communication between the pods 240 and 244 and the database storage 256. In some implementations, the load balancer 228 can distribute workload between the pods 240 and 244. Balancing the on-demand service requests between the pods can assist in improving the use of resources, increasing throughput, reducing response times, or reducing overhead. The load balancer 228 may include multilayer switches to analyze and forward traffic.

In some implementations, access to the database storage 256 is guarded by a database firewall 248. The database firewall 248 can act as a computer application firewall operating at the database application layer of a protocol stack. The database firewall 248 can protect the database storage 256 from application attacks such as SQL injection, database rootkits, and unauthorized information disclosure. In some implementations, the database firewall 248 includes a host using one or more forms of reverse proxy services to proxy traffic before passing it to a gateway router. The database firewall 248 can inspect the contents of database traffic and block certain content or database requests. The database firewall 248 can work on the SQL application level atop the TCP/IP stack, managing applications' connection to the database or SQL management interfaces as well as intercepting and enforcing packets traveling to or from a database network or application interface.

In some implementations, communication with the database storage 256 is conducted via the database switch 252. The multi-tenant database storage 256 can include more than one hardware or software components for handling database queries. Accordingly, the database switch 252 can direct database queries transmitted by other components of the on-demand database service environment (for example, the pods 240 and 244) to the correct components within the database storage 256. In some implementations, the database storage 256 is an on-demand database system shared by many different organizations as described above with reference to FIGS. 1A and 1B.

FIG. 2B shows a system diagram further illustrating example architectural components of an on-demand database service environment according to some implementations. The pod 244 can be used to render services to a user of the on-demand database service environment 200. In some implementations, each pod includes a variety of servers or other systems. The pod 244 includes one or more content batch servers 264, content search servers 268, query servers 282, file servers 286, access control system (ACS) servers 280, batch servers 284, and app servers 288. The pod 244 also can include database instances 290, quick file systems (QFS) 292, and indexers 294. In some implementations, some or all communication between the servers in the pod 244 can be transmitted via the pod switch 236.

In some implementations, the app servers 288 include a hardware or software framework dedicated to the execution of procedures (for example, programs, routines, scripts) for supporting the construction of applications provided by the on-demand database service environment 200 via the pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 264 can handle requests internal to the pod. Some such requests can be long-running or not tied to a particular customer. For example, the content batch servers 264 can handle requests related to log mining, cleanup work, and maintenance tasks. The content search servers 268 can provide query and indexer functions. For example, the functions provided by the content search servers 268 can allow users to search through content stored in the on-demand database service environment. The file servers 286 can manage requests for information stored in the file storage 298. The file storage 298 can store information such as documents, images, and binary large objects (BLOBs). By managing requests for information using the file servers 286, the image footprint on the database can be reduced. The query servers 282 can be used to retrieve information from one or more file systems. For example, the query servers 282 can receive requests for information from the app servers 288 and transmit information queries to the network file systems (NFS) 296 located outside the pod.

The pod 244 can share a database instance 290 configured as a multi-tenant environment in which different organizations share access to the same database. Additionally, services rendered by the pod 244 may call upon various hardware or software resources. In some implementations, the ACS servers 280 control access to data, hardware resources, or software resources. In some implementations, the batch servers 284 process batch jobs, which are used to run tasks at specified times. For example, the batch servers 284 can transmit instructions to other servers, such as the app servers 288, to trigger the batch jobs.

In some implementations, the QFS 292 is an open source file system available from Sun Microsystems, Inc. The QFS can serve as a rapid-access file system for storing and accessing information available within the pod 244. The QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in the NFS 296 or other storage systems.

In some implementations, one or more query servers 282 communicate with the NFS 296 to retrieve or update information stored outside of the pod 244. The NFS 296 can allow servers located in the pod 244 to access information to access files over a network in a manner similar to how local storage is accessed. In some implementations, queries from the query servers 282 are transmitted to the NFS 296 via the load balancer 228, which can distribute resource requests over various resources available in the on-demand database service environment. The NFS 296 also can communicate with the QFS 292 to update the information stored on the NFS 296 or to provide information to the QFS 292 for use by servers located within the pod 244.

In some implementations, the pod includes one or more database instances 290. The database instance 290 can transmit information to the QFS 292. When information is transmitted to the QFS, it can be available for use by servers within the pod 244 without using an additional database call. In some implementations, database information is transmitted to the indexer 294. Indexer 294 can provide an index of information available in the database instance 290 or QFS 292. The index information can be provided to the file servers 286 or the QFS 292.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring instructions for performing such methods to computing devices. The term “article of manufacture,” as used herein, is intended to encompass a computer program accessible from any computer-readable device or storage media.

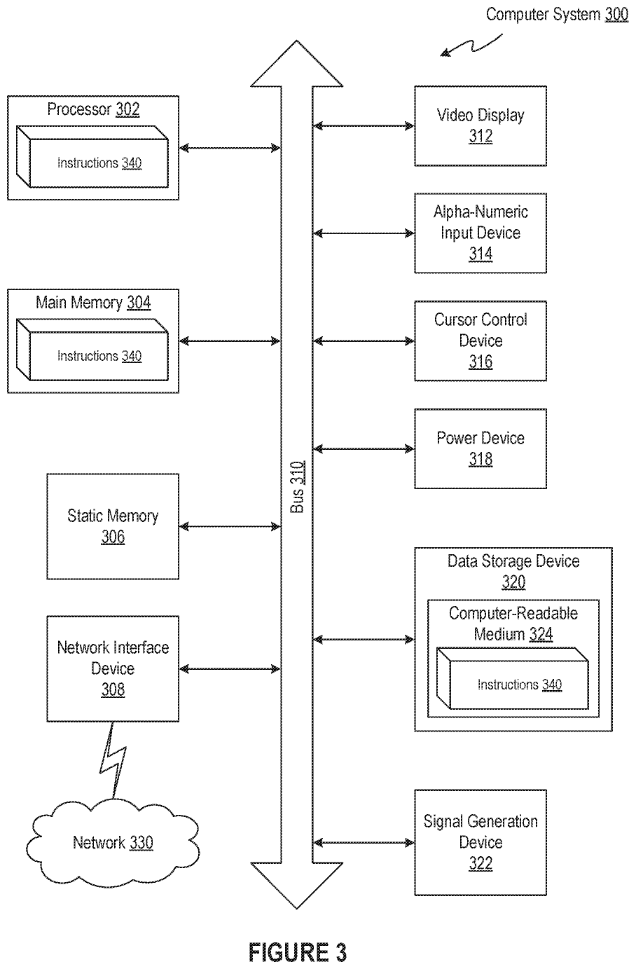

FIG. 3 illustrates a diagrammatic representation of a machine in the exemplary form of a computer system 300 within which a set of instructions (e.g., for causing the machine to perform any one or more of the methodologies discussed herein) may be executed. In alternative implementations, the machine may be connected (e.g., networked) to other machines in a LAN, a WAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a PDA, a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 300 may be utilized by or illustrative of any of the electronic components described herein (e.g., any of the components illustrated in or described with respect to FIGS. 1A, 1B, 2A, and 2B).

The exemplary computer system 300 includes a processing device (processor) 302, a main memory 304 (e.g., ROM, flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a data storage device 320, which communicate with each other via a bus 310.

Processor 302 represents one or more general-purpose processing devices such as a microprocessor, central processing unit, or the like. More particularly, the processor 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 302 may also be one or more special-purpose processing devices such as an application specific integrated circuit (ASIC), a field programmable gate array (FPGA), a digital signal processor (DSP), network processor, or the like. The processor 302 is configured to execute instructions 340 for performing the operations and steps discussed herein.

The computer system 300 may further include a network interface device 308. The computer system 300 also may include a video display unit 312 (e.g., a liquid crystal display (LCD), a cathode ray tube (CRT), or a touch screen), an alphanumeric input device 314 (e.g., a keyboard), a cursor control device 316 (e.g., a mouse), and a signal generation device 322 (e.g., a speaker).

Power device 318 may monitor a power level of a battery used to power the computer system 300 or one or more of its components. The power device 318 may provide one or more interfaces to provide an indication of a power level, a time window remaining prior to shutdown of computer system 300 or one or more of its components, a power consumption rate, an indicator of whether computer system is utilizing an external power source or battery power, and other power related information. In some implementations, indications related to the power device 318 may be accessible remotely (e.g., accessible to a remote back-up management module via a network connection). In some implementations, a battery utilized by the power device 318 may be an uninterruptable power supply (UPS) local to or remote from computer system 300. In such implementations, the power device 318 may provide information about a power level of the UPS.

The data storage device 320 may include a computer-readable storage medium 324 (e.g., a non-transitory computer-readable storage medium) on which is stored one or more sets of instructions 340 (e.g., software) embodying any one or more of the methodologies or functions described herein. These instructions 340 may also reside, completely or at least partially, within the main memory 304 and/or within the processor 302 during execution thereof by the computer system 300, the main memory 304, and the processor 302 also constituting computer-readable storage media. The instructions 340 may further be transmitted or received over a network 330 (e.g., the network 14) via the network interface device 308. While the computer-readable storage medium 324 is shown in an exemplary implementation to be a single medium, it is to be understood that the computer-readable storage medium 324 may include a single medium or multiple media (e.g., a centralized or distributed database, and/or associated caches and servers) that store the one or more sets of instructions 340.

### ENTERPRISE SOCIAL NETWORKING

As initially described above, in some implementations, some of the methods, processes, devices, and systems described herein can implement, or be used in the context of, enterprise social networking. An “enterprise” refers generally to a company or organization that owns one or more data centers that host various services and data sources. A “data center” refers generally to a physical location of various servers, machines, and network components utilized by an enterprise. Some online enterprise social networks can be implemented in various settings, including businesses, organizations, and other enterprises (all of which are used interchangeably herein). For instance, an online enterprise social network can be implemented to connect users within a business corporation, partnership, or organization, or a group of users within such an enterprise. For instance, Chatter® can be used by users who are employees in a business organization to share data, communicate, and collaborate with each other for various enterprise-related purposes. Some of the disclosed methods, processes, devices, systems, and computer-readable storage media described herein can be configured or designed for use in a multi-tenant database environment, such as described above with respect to the database system 16. In an example implementation, each organization or a group within the organization can be a respective tenant of the system.

In some implementations, each user of the database system 16 is associated with a “user profile.” A user profile refers generally to a collection of data about a given user. The data can include general information, such as a name, a title, a phone number, a photo, a biographical summary, or a status (for example, text describing what the user is currently doing, thinking, or expressing). As described below, the data can include messages created by other users. In implementations in which there are multiple tenants, a user is typically associated with a particular tenant (or “organization”). For example, a user could be a salesperson of an organization that is a tenant of the database system 16. As used herein, a “customer” may be an individual or organization that receives emails or other data and communications from a user. A customer may also be a user in certain scenarios.

A “group” generally refers to a collection of users within an organization. In some implementations, a group can be defined as users with one or more same or a similar attributes, or by membership or subscription. Groups can have various visibilities to users within an enterprise social network. For example, some groups can be private while others can be public. In some implementations, to become a member within a private group, and to have the capability to publish and view feed items on the group's group feed, a user must request to be subscribed to the group (and be accepted by, for example, an administrator or owner of the group), be invited to subscribe to the group (and accept), or be directly subscribed to the group (for example, by an administrator or owner of the group). In some implementations, any user within the enterprise social network can subscribe to or follow a public group (and thus become a “member” of the public group) within the enterprise social network.

A “record” generally refers to a data entity, such as an instance of a data object created by a user or group of users of the database system 16. Such records can include, for example, data objects representing and maintaining data for accounts, cases, opportunities, leads, files, documents, orders, pricebooks, products, solutions, reports, and forecasts, among other possibilities. For example, a record can be for a partner or potential partner (for example, a client, vendor, distributor, etc.) of a user or a user's organization, and can include information describing an entire enterprise, subsidiaries of an enterprise, or contacts at the enterprise. As another example, a record can be a project that a user or group of users is/are working on, such as an opportunity with an existing partner, or a project that the user is trying to obtain. A record has data fields that are defined by the structure of the object (for example, fields of certain data types and purposes). A record also can have custom fields defined by a user or organization. A field can include (or include a link to) another record, thereby providing a parent-child relationship between the records.

Records also can have various visibilities to users within an enterprise social network. For example, some records can be private while others can be public. In some implementations, to access a private record, and to have the capability to publish and view feed items on the record's record feed, a user must request to be subscribed to the record (and be accepted by, for example, an administrator or owner of the record), be invited to subscribe to the record (and accept), be directly subscribed to the record or be shared the record (for example, by an administrator or owner of the record). In some implementations, any user within the enterprise social network can subscribe to or follow a public record within the enterprise social network.

In some online enterprise social networks, users also can follow one another by establishing “links” or “connections” with each other, sometimes referred to as “friending” one another. By establishing such a link, one user can see information generated by, generated about, or otherwise associated with another user. For instance, a first user can see information posted by a second user to the second user's profile page. In one example, when the first user is following the second user, the first user's news feed can receive a post from the second user submitted to the second user's profile feed.

In some implementations, users can access one or more enterprise network feeds (also referred to herein simply as “feeds”), which include publications presented as feed items or entries in the feed. A network feed can be displayed in a graphical user interface (GUI) on a display device such as the display of a user's computing device as described above. The publications can include various enterprise social network information or data from various sources and can be stored in the database system 16, for example, in tenant database 22. In some implementations, feed items of information for or about a user can be presented in a respective user feed, feed items of information for or about a group can be presented in a respective group feed, and feed items of information for or about a record can be presented in a respective record feed. A second user following a first user, a first group, or a first record can automatically receive the feed items associated with the first user, the first group, or the first record for display in the second user's news feed. In some implementations, a user feed also can display feed items from the group feeds of the groups the respective user subscribes to, as well as feed items from the record feeds of the records the respective user subscribes to.

The term “feed item” (or feed element) refers to an item of information, which can be viewable in a feed. Feed items can include publications such as messages (for example, user-generated textual posts or comments), files (for example, documents, audio data, image data, video data or other data), and “feed-tracked” updates associated with a user, a group, or a record (feed-tracked updates are described in greater detail below). A feed item, and a feed in general, can include combinations of messages, files, and feed-tracked updates. Documents and other files can be included in, linked with, or attached to a post or comment. For example, a post can include textual statements in combination with a document. The feed items can be organized in chronological order or another suitable or desirable order (which can be customizable by a user) when the associated feed is displayed in a graphical user interface (GUI), for instance, on the user's computing device.

Messages such as posts can include alpha-numeric or other character-based user inputs such as words, phrases, statements, questions, emotional expressions, or symbols. In some implementations, a comment can be made on any feed item. In some implementations, comments are organized as a list explicitly tied to a particular feed item such as a feed-tracked update, post, or status update. In some implementations, comments may not be listed in the first layer (in a hierarchal sense) of feed items, but listed as a second layer branching from a particular first layer feed item. In some implementations, a “like” or “dislike” also can be submitted in response to a particular post, comment, or other publication.

A “feed-tracked update,” also referred to herein as a “feed update,” is another type of publication that may be presented as a feed item and generally refers to data representing an event. A feed-tracked update can include text generated by the database system in response to the event, to be provided as one or more feed items for possible inclusion in one or more feeds. In one implementation, the data can initially be stored by the database system in, for example, tenant database 22, and subsequently used by the database system to create text for describing the event. Both the data and the text can be a feed-tracked update, as used herein. In some implementations, an event can be an update of a record and can be triggered by a specific action by a user. Which actions trigger an event can be configurable. Which events have feed-tracked updates created and which feed updates are sent to which users also can be configurable. Messages and feed updates can be stored as a field or child object of a record. For example, the feed can be stored as a child object of the record.

As described above, a network feed can be specific to an individual user of an online social network. For instance, a user news feed (or “user feed”) generally refers to an aggregation of feed items generated for a particular user, and in some implementations, is viewable only to the respective user on a home page of the user. In some implementations a user profile feed (also referred to as a “user feed”) is another type of user feed that refers to an aggregation of feed items generated by or for a particular user, and in some implementations, is viewable only by the respective user and other users following the user on a profile page of the user. As a more specific example, the feed items in a user profile feed can include posts and comments that other users make about or send to the particular user, and status updates made by the particular user. As another example, the feed items in a user profile feed can include posts made by the particular user and feed-tracked updates initiated based on actions of the particular user.

As is also described above, a network feed can be specific to a group of enterprise users of an online enterprise social network. For instance, a group news feed (or “group feed”) generally refers to an aggregation of feed items generated for or about a particular group of users of the database system 16 and can be viewable by users following or subscribed to the group on a profile page of the group. For example, such feed items can include posts made by members of the group or feed-tracked updates about changes to the respective group (or changes to documents or other files shared with the group). Members of the group can view and post to a group feed in accordance with a permissions configuration for the feed and the group. Publications in a group context can include documents, posts, or comments. In some implementations, the group feed also includes publications and other feed items that are about the group as a whole, the group's purpose, the group's description, a status of the group, and group records and other objects stored in association with the group. Threads of publications including updates and messages, such as posts, comments, likes, etc., can define conversations and change over time. The following of a group allows a user to collaborate with other users in the group, for example, on a record or on documents or other files (which may be associated with a record).

As is also described above, a network feed can be specific to a record in an online enterprise social network. For instance, a record news feed (or “record feed”) generally refers to an aggregation of feed items about a particular record in the database system 16 and can be viewable by users subscribed to the record on a profile page of the record. For example, such feed items can include posts made by users about the record or feed-tracked updates about changes to the respective record (or changes to documents or other files associated with the record). Subscribers to the record can view and post to a record feed in accordance with a permissions configuration for the feed and the record. Publications in a record context also can include documents, posts, or comments. In some implementations, the record feed also includes publications and other feed items that are about the record as a whole, the record's purpose, the record's description, and other records or other objects stored in association with the record. Threads of publications including updates and messages, such as posts, comments, likes, etc., can define conversations and change over time. The following of a record allows a user to track the progress of that record and collaborate with other users subscribing to the record, for example, on the record or on documents or other files associated with the record.

In some implementations, data is stored in the database system 16, including tenant database 22, in the form of “entity objects” (also referred to herein simply as “entities”). In some implementations, entities are categorized into “Records objects” and “Collaboration objects.” In some such implementations, the Records object includes all records in the enterprise social network. Each record can be considered a sub-object of the overarching Records object. In some implementations, Collaboration objects include, for example, a “Users object,” a “Groups object,” a “Group-User relationship object,” a “Record-User relationship object,” and a “Feed Items object.”

In some implementations, the Users object is a data structure that can be represented or conceptualized as a “Users Table” that associates users to information about or pertaining to the respective users including, for example, metadata about the users. In some implementations, the Users Table includes all of the users within an organization. In some other implementations, there can be a Users Table for each division, department, team or other sub-organization within an organization. In implementations in which the organization is a tenant of a multi-tenant enterprise social network platform, the Users Table can include all of the users within all of the organizations that are tenants of the multi-tenant enterprise social network platform. In some implementations, each user can be identified by a user identifier (“UserID”) that is unique at least within the user's respective organization. In some such implementations, each organization also has a unique organization identifier (“OrgID”).

In some implementations, the Groups object is a data structure that can be represented or conceptualized as a “Groups Table” that associates groups to information about or pertaining to the respective groups including, for example, metadata about the groups. In some implementations, the Groups Table includes all of the groups within the organization. In some other implementations, there can be a Groups Table for each division, department, team, or other sub-organization within an organization. In implementations in which the organization is a tenant of a multi-tenant enterprise social network platform, the Groups Table can include all of the groups within all of the organizations that are tenants of the multitenant enterprise social network platform. In some implementations, each group can be identified by a group identifier (“GroupID”) that is unique at least within the respective organization.

In some implementations, the database system 16 includes a “Group-User relationship object.” The Group-User relationship object is a data structure that can be represented or conceptualized as a “Group-User Table” that associates groups to users subscribed to the respective groups. In some implementations, the Group-User Table includes all of the groups within the organization. In some other implementations, there can be a Group-User Table for each division, department, team, or other sub-organization within an organization. In implementations in which the organization is a tenant of a multi-tenant enterprise social network platform, the Group-User Table can include all of the groups within all of the organizations that are tenants of the multitenant enterprise social network platform.

In some implementations, the Records object is a data structure that can be represented or conceptualized as a “Records Table” that associates records to information about or pertaining to the respective records including, for example, metadata about the records. In some implementations, the Records Table includes all of the records within the organization. In some other implementations, there can be a Records Table for each division, department, team, or other sub-organization within an organization. In implementations in which the organization is a tenant of a multi-tenant enterprise social network platform, the Records Table can include all of the records within all of the organizations that are tenants of the multitenant enterprise social network platform. In some implementations, each record can be identified by a record identifier (“RecordID”) that is unique at least within the respective organization.

In some implementations, the database system 16 includes a “Record-User relationship object.” The Record-User relationship object is a data structure that can be represented or conceptualized as a “Record-User Table” that associates records to users subscribed to the respective records. In some implementations, the Record-User Table includes all of the records within the organization. In some other implementations, there can be a Record-User Table for each division, department, team, or other sub-organization within an organization. In implementations in which the organization is a tenant of a multi-tenant enterprise social network platform, the Record-User Table can include all of the records within all of the organizations that are tenants of the multitenant enterprise social network platform.

In some implementations, the database system 16 includes a “Feed Items object.” The Feed Items object is a data structure that can be represented or conceptualized as a “Feed Items Table” that associates users, records, and groups to posts, comments, documents, or other publications to be displayed as feed items in the respective user feeds, record feeds, and group feeds, respectively. In some implementations, the Feed Items Table includes all of the feed items within the organization. In some other implementations, there can be a Feed Items Table for each division, department, team, or other sub-organization within an organization. In implementations in which the organization is a tenant of a multi-tenant enterprise social network platform, the Feed Items Table can include all of the feed items within all of the organizations that are tenants of the multitenant enterprise social network platform.

Enterprise social network news feeds are different from typical consumer-facing social network news feeds (for example, FACEBOOK®) in many ways, including in the way they prioritize information. In consumer-facing social networks, the focus is generally on helping the social network users find information that they are personally interested in. But in enterprise social networks, it can, in some instances, applications, or implementations, be desirable from an enterprise's perspective to only distribute relevant enterprise-related information to users and to limit the distribution of irrelevant information. In some implementations, relevant enterprise-related information refers to information that would be predicted or expected to benefit the enterprise by virtue of the recipients knowing the information, such as an update to a database record maintained by or on behalf of the enterprise. Thus, the meaning of relevance differs significantly in the context of a consumer-facing social network as compared with an employee-facing or organization member-facing enterprise social network.

In some implementations, when data such as posts or comments from one or more enterprise users are submitted to a network feed for a particular user, group, record or other object within an online enterprise social network, an email notification, or other type of network communication may be transmitted to all users following the respective user, group, record, or object in addition to the inclusion of the data as a feed item in one or more user, group, record, or other feeds. In some online enterprise social networks, the occurrence of such a notification is limited to the first instance of a published input, which may form part of a larger conversation. For instance, a notification may be transmitted for an initial post, but not for comments on the post. In some other implementations, a separate notification is transmitted for each such publication, such as a comment on a post.

### LANGUAGE ANALYSIS PLATFORM

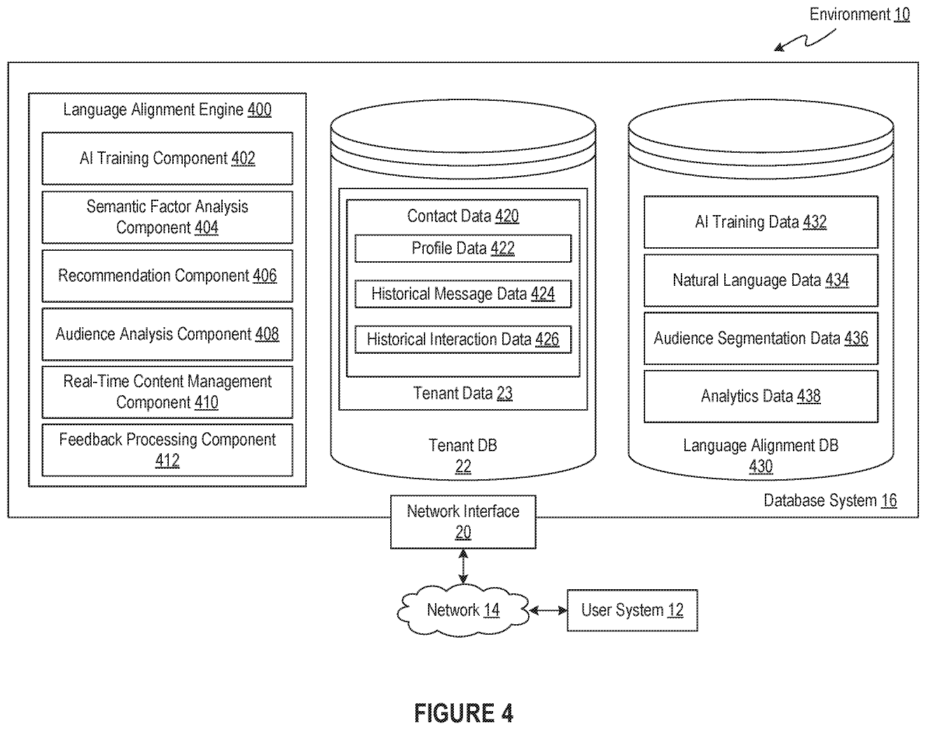

Reference is now made to FIG. 4, which shows a block diagram illustrating the components of a language alignment engine 400 according to some implementations. The language alignment engine 400 is shown and described as being implemented by the database system 16 within the framework of the environment 10, however, this is merely illustrative as other implementations outside of the environment 10 are contemplated.

The language alignment engine 400 includes: an AI training component 402 for training one or more AI models utilized for performing semantic factor analysis and identifying and parsing relevant natural language; a semantic factor analysis component 404 for deriving semantic factors from proposed content; a recommendation component 406 to generate content, content edits, or suggestions for new content based on comparisons of computed semantic factors to recipient preferences; an audience analysis component 408 for performing audience segmentation and generating predictions of how audience segments may respond to certain types of content; a real-time content management component 410 for generating real-time content updates for automated messaging systems; and a feedback processing component 412 for updating recipient profile information based on recipient feedback to customized messages.

The database system 16 further includes a language alignment database 430, which may store system-level data for the language alignment engine 400, such as AI training data 432 descriptive of one or more AI models, natural language data 434 utilized by the recommendation component 406, audience segmentation data 436 that defines groups of individual recipients having similar messaging preferences or characteristics, and analytics data 438 descriptive of messaging success metrics for audience segments.

The language alignment engine 400 may initially receive proposed content from an individual or organization (e.g., a user system 12 associated with the individual or organization) seeking to have the content aligned to its target recipient. For example, if the proposed content is from marketing personnel, it will generally be in the form of a proposed email or other marketing content prepared for individual recipients, groups, or an audience. As another example, the proposed content may be received from a chatbot application (e.g., that may be implemented by the database system 16 or external to the database system 16) in order to have its chat questions or responses aligned to its target recipient.

The target recipient may be specified together with the proposed content, and may identify an individual recipient, group of recipients, or an audience. Individuals and groups of individuals may be specified by specific points of contact, such as email addresses, telephone numbers, etc. An audience is similar to a group of contacts, except that individual contact information is not directly specified. Instead, target recipient data may indicate a particular profile, profile type, or marketing segment, which the audience analysis component 408 utilizes to identify individual points of contact to which the proposed content is to be sent.

In some implementations, the AI training component 402 generates and maintains AI models used for computing semantic factors, parsing natural language, and processing and interpreting recipient feedback. AI training data 432 may include semantic factor data, which may be used to train the AI models based on defined rules and feedback to predict semantic factors. In some implementations, the AI training component 402 utilizes one or more of a decision tree or a support vector machine (SVM). An AI model may comprise single level of linear or non-linear operations (e.g., SVM) or may be a deep network (e.g., a machine learning model that is composed of multiple levels of non-linear operations). In some implementations, the AI training component 402 may use an SVM gradient algorithm. The SVM gradient algorithm may be used to predict semantic factors and positive recipient responses based on gradient boosting regression.

In some implementations, the semantic factor analysis component 404 evaluates numerous details of the proposed content, utilizing, for example, well-defined algorithms such as those used for determining reading grade level of the language and for detecting technical terms. Other algorithms may be AI-based, leveraging AI training data 432, to identify semantic factors such as tone, style, and urgency. The resulting data may be utilized as a baseline for further semantic factor analysis. In some implementations, the AI model may be trained to analyze sentiment and context in images and text pertaining to, for example, colorblind accessibility, comprehension level, diversity of characters in marketing images (e.g., some marketing photos are obviously aggressively diverse while others are diversity oblivious), political leanings, environmental concerns, etc.

In some implementations, natural language processing may be implemented using pre-trained classifiers to look for different styles (e.g. humorous, direct, empathetic, etc.). Readability (e.g., in terms of the presence of technical or non-technical language) may be computed by generating readability scores (e.g., using Flesch-Kincaid readability analysis, Gunning Fog index analysis, etc.). In some implementations, natural language processing classifiers may be pretrained (e.g., by the AI training component 402). These natural language processing algorithms may be used to generate confidence scores (e.g. 61% humorous), which can be aggregated in a number of ways (e.g. take the average score for each sentence for an overall score) and presented to the individual providing the proposed content as an indicator of whether they are in compliance with the recommendations of the language alignment engine 400. In some implementations, this may be performed in real-time as the individual is drafting the proposed content.

Depending on the target recipient for the proposed content, relevant profile data may be directly stored at the account level (e.g., profile data 422 associated with contact data 420), and/or may be extracted or retrieved from, for example, social media data or other public data sources associated with the recipient (e.g., data descriptive of educational level, geographic data, etc.).

The channel through which the proposed content is being delivered may also be factored into the analysis. For example, text messages are generally more informal than email messages or marketing materials, and the level of formality in recommended content edits may be adjusted accordingly.

In some implementations, the recommendation component 406 compares the semantic factors extracted from the proposed content to the profile data 422 (or the audience segmentation data 436 if the target recipient is an audience) to identify deviations from the computed semantic factors and the preferred semantic factors for the recipient. For example, if the recipient has no medical background and only a high-school education, the recommendation component 406 may identify as a deviation (“gap”) portions of the proposed content includes medical terminology.

In some implementations, the audience analysis component 408 may compile profile data 422 from various recipients or groups of recipients and store this information as audience segmentation data 436. The data model represented in the audience segmentation data 436 may include short term to long term success indicators for use in the gap analysis described above. Such indicators may include, for example, email open rates as short term success indicators, response rates as medium term success indicators, and product purchases as long term success indicators.

In some implementations, data science techniques, such as K-means clustering to group each user with a particular segment. For example, each segment may be represented as a combination of different complexities and styles, which may be determined by individual response rates to prior emails that fit each combination of complexity and style. The segments may be represented visually in Table 1, which shows nine segments defined as a two-dimensional grid (e.g., individuals who respond to non-technical and direct content, individuals who respond to humorous and highly technical content, etc.). For each segment, a predicted positive response rate and a size of the audience who prefers that combination of style and complexity is shown. The success indicators from the audience segmentation data 436 may be used to predict positive response rates (percentages) based on the particular segment and the size of the segment that responded.

The audience analysis component 408 may utilize this data to suggest different types of content (e.g., marketing copy) to be produced, each targeting a different cross-section of the audience that responds best to a particular style. Variants of content may be suggested using calculations of expected impact based on the size and expected response of the audience.

In the example of Table 1, direct/highly technical and humorous/non-technical segments scored well and have relatively large audiences, so they would be predicted to have the greatest impact. In some implementations, this information would be provided to content developers in the form of recommendations for content that should be developed for maximum impact. The recommendations may also suggest to the content developer that different content variants for segments with low predicted response rates and small audiences, thus saving time, effort, and money for copywriting. In this particular example, the recommendation component 406 may recommend that content for empathetic/moderately technical, empathetic/highly technical, and humorous/very technical need not be created as the expected positive response rates are too low to justify the effort required to generate content for these audience segments.

TABLE 1
Example of predicted positive response rates for audience
segmentation based on a two-factor segmentation model

| | | | Complexity | | | |
|---|---|---|---|---|---|---|
| | | Non- | Moderately | | Highly | |
| | | technical | technical | | technical | |
| | Direct | 15% (523) | 16% | (1023) | 37% | (1234) |
| Style | Humorous | 31% (843) | 10% | (654) | 8% | (133) |
| | Empathetic | 11% (434) | 6% | (234) | 4% | (45) |

In some implementations, the recommendation component 406 may apply appropriate translations to proposed content in the form of recommended edits. In some implementations, multiple suggested edits may be generated that could be applied in marketing campaigns to enable A-B testing of different styles which are then applied as feedback to further refine future recommendations. The recommended edits could be used immediately or provided to the individual or entity providing the proposed content (e.g., as one or more edits appearing next to or overlaid on the proposed content for comparison purposes). In some implementations, multiple alternative edits may be provided to provide the individual or entity with options to select based on their perspective or preferences. In some implementations, the individual may accept some edits but reject others. For example, the recommendation component 406 may suggest more slang or information language than the individual is comfortable with sending to the target recipient and the individual may reject these recommended edits, but may accept edits that introduce more technical language.

In some implementations, the feedback processing component 412 tracks feedback received from recipients of edited content, storing messages in historical message data 424, storing feedback-related actions (e.g., open rates, click-through events, product purchases, etc.) in historical interaction data 426, and updating profile data 422 based on analysis of recipient interactions.

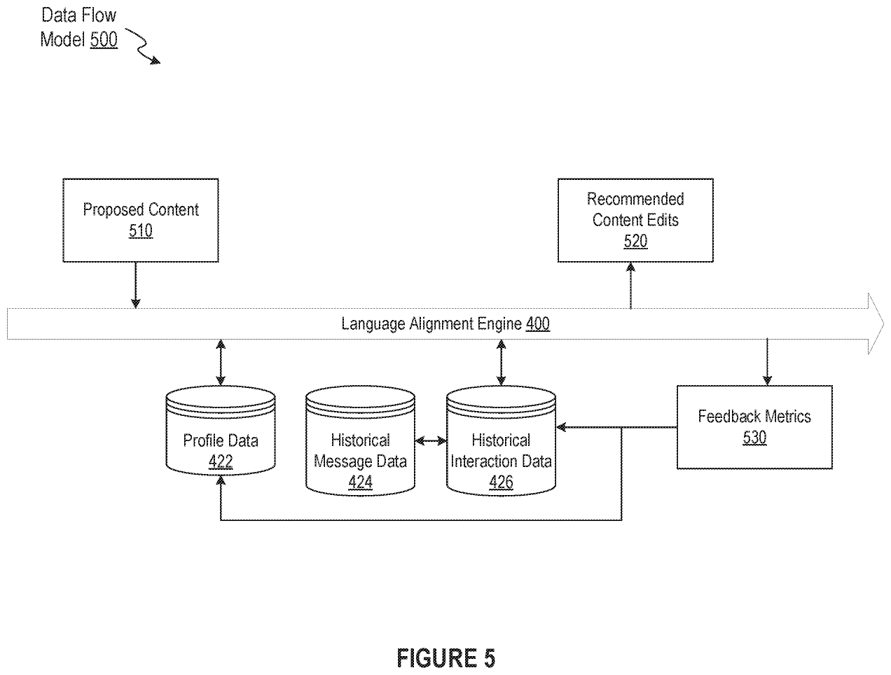

FIG. 5 is a data flow model illustrating the functionality of a language alignment engine according to some implementations. Initially, proposed content 510 is sent to/received by the language alignment engine 400. The semantic factor analysis component 404 evaluates the proposed content 510 to compute semantic factors descriptive of grade level, tone, etc. with associated confidence scores. Profile data 422 associated with the target recipient of the proposed content 510 is then retrieved/identified and compared to the computed semantic factors. Based on the target recipient (e.g., individual, group of individuals, or audience) and the type of content, historical interaction data 426 is retrieved/identified. “Gaps” between the semantic factors of the proposed content 510 and preferred semantic factors of the profile data 422 are identified, and historically similar messages from the historical message data 424 are identified based on successful interactions identified and stored in the historical interaction data 426. The recommendation component 406 then utilizes natural language data 434 to “translate” the identified portions of the proposed content 510 to better align with the preferred semantic factors, which may be presented as recommended content edits 520. After modifying the proposed content 510 based on the recommended content edits 520 and transmitting the modified content to the target recipient, feedback metrics 530 may be collected based on actions taken by the target recipient (e.g., response messages and analysis of the content, open rates, click-through events, etc.). The feedback processing component 412 accordingly processes the feedback metrics 530 and updates the historical interaction data 426 and the profile data 422.

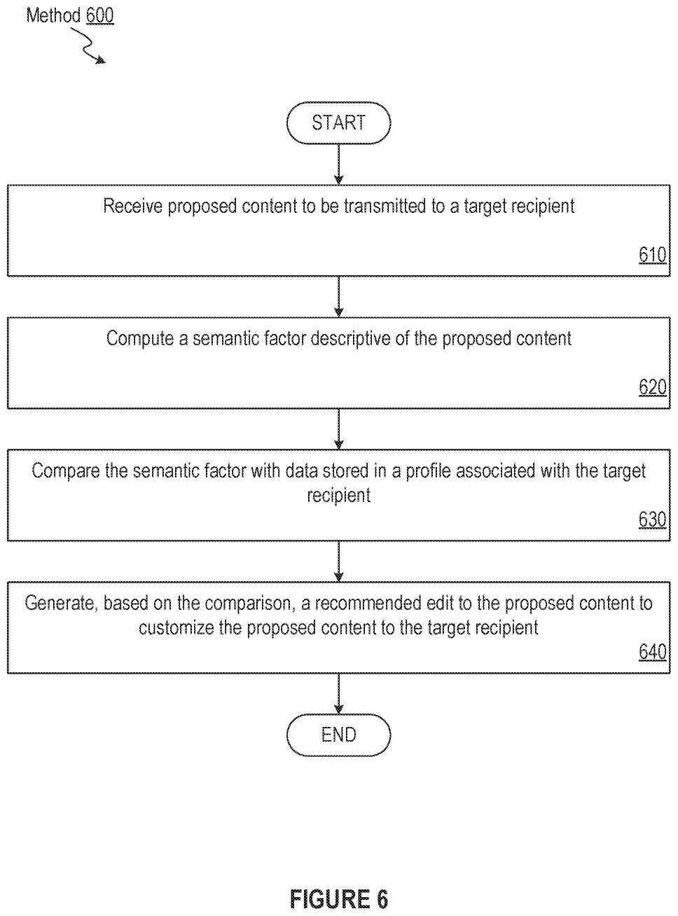

Reference is now made to FIG. 6, which is a flow diagram illustrating an exemplary method 600 for performing message language analysis based on target recipient profile data according to some implementations. The method 600 may be performed by processing logic comprising hardware (e.g., circuitry, dedicated logic, programmable logic, microcode, etc.), software (such as instructions run on a processing device), or a combination thereof. In some implementations, the method 600 may be performed by a database system (e.g., the database system 16). It is to be understood that these implementations are merely exemplary, and that other devices may perform some or all of the functionality described.

Referring to FIG. 6, at block 610, a processing device (e.g., a processing device of a database system 16) receives proposed content to be transmitted to a target recipient. In some implementations, the proposed content comprises text content to be sent in the form of an email, and text message (e.g., a short message service (SMS) message), an instant message or chat message, a social media post, a website posting, an electronic document. In addition to text, the text content may include other visual content, such as emojis or other images (e.g., images that visually display text or convey context or sentiment). In implementations where the text includes images, the images may include associated metadata that is utilized in the computation of semantic factors, as discussed below with respect to block 620. In some implementations, the proposed content need not be content that is transmitted electronically to the target recipient. For example, the proposed content may include digital content that is ultimately printed and physically sent to the target recipient.

The target recipient may be, for example, an individual recipient, a group of individual recipients, or an audience (e.g., a segment of a group of marketing contacts). In some implementations, the proposed content may comprise an identifier of the target recipient, such as one or more email addresses, one or more telephone numbers, or any other suitable identifier.

At block 620, the processing device computes a semantic factor descriptive of the proposed content. In some implementations, the semantic factor is representative of a tone, style, grade level, or complexity of the proposed content. The semantic factor may be computed, for example, as discussed with respect to the semantic factor analysis component 404 of FIG. 4.

In some implementations, multiple semantic factors may be computed for the proposed content. Semantic factors may be computed on a paragraph level, on a sentence level, on a sub-sentence or clause level, or on a word level. For example, if the proposed content is an email with a subject line and a three-sentence body, the processing device may compute a semantic factor descriptive of the subject line, and one semantic factor each of the three sentences. In another example, the processing device may compute semantic factors for individual words or groups of words. In some implementations, more than one semantic factor may be computed for the same portion of the proposed content. For example, the processing device may compute, for a given sentence, more than one semantic factor, such as a tone and complexity factor for that sentence.

At block 630, the processing device compares the semantic factor with data stored in a profile associated with the target recipient. In some implementations, the profile comprises information indicative of preferred semantic factors for the individual recipient, the group of individual recipients, or the audience, which may be retrieved from a database (e.g., the tenant database 22). For example, for an individual recipient, the processing device may obtain the profile data from contact data associated with that individual recipient (e.g., profile data 422 stored in contact data 420). In some implementations where the recipient is a group of recipients, the processing device may aggregate profile data associated with each individual contact (e.g., from the tenant database 22). In some implementations where the recipient is an audience, the processing device may obtain or derive profile data based on audience segmentation and analytics for the specified audience (e.g., based on audience segmentation data 436 and analytics data 438).

In some implementations, the processing device compares the semantic factor with data stored in the profile(s) associated with the target recipient by identifying one or more portions of the proposed content that fail to match a preferred semantic factor of the target recipient. For example, for an individual recipient, the processing device may determine that an overall tone (e.g., direct or professional) of the proposed content does not match the individual recipient's preferred tone (e.g., humorous). In another example, the processing device may determine that various portions (e.g., sentences) of the proposed content are technically simple and consistent with the target recipient's preferred complexity level, but may identify a single portion (e.g., sentence or word) that is technically complex and thus inconsistent with the target recipient's preferred complexity level.

At block 640, the processing device generates, based on the comparison, a recommended edit to the proposed content to customize the proposed content to the target recipient. The recommended edit may include, for example, similar content that matches the preferred semantic factor of the target recipient and conveys the same or similar meaning as the proposed content. For example, if a sentence of the proposed content is identified as not matching a preferred semantic factor of the target recipient's profile, the processing device may identify or generate (e.g., based on the natural language data 434) a sentence that aligns with the preferred semantic factor to replace the sentence of the proposed content. Similarly, in another example, if a particular word in the proposed content is determined to be more complex than the target recipient prefers, the processing device may identify a less complex word with the same or similar meaning to replace the complex word.

In some implementations, generating the recommended edit to the proposed content comprises generating the recommended edit based on language derived from a historical interaction with the target recipient. For example, in some implementations, the processing device identifies historical interactions with the target recipient based on success metrics of such historical interactions (e.g., interactions identified in historical interaction data 426). Such success metrics are indicative of a positive response by the target recipient to the historical interaction, including, but not limited to, words, sentences, or phrases by the target recipient representative of a positive interaction (e.g., “Thank you,” “I agree,” “Great!”), or interactive events, such as opening an email, a click-through event, or a purchase. Metrics indicative of positive responses may also account for variations in punctuation and capitalization (e.g., “Great . . . ” may be interpreted as unfavorable or less favorable than “Great!”; “Great!” may be interpreted as less favorable than “GREAT!”). In such implementations, the recommended edit may be generated to include or may be derived at least partially from language of the successful historical interaction (e.g., language stored in historical message data 424).

In some implementations, the recommended edit is applied to the proposed content to generate edited content. In some implementations, if the proposed content was generated by an individual (e.g., using a text editor), the recommended edit is provided to the individual for his/her approval prior to applying the recommended edit. In some implementations where the target recipient includes a group of individual recipients, the processing device may generate recommended edits specific to each individual recipient in the group, and may apply the recommended edits to generate a plurality of edited content items that are each customized for individual recipients in the group. In some implementations, the recommended edit is applied automatically. For example, in a chatbot application, recommended edits may be applied automatically to messages generated by the chatbot during real-time interaction with a target recipient. Once the edited content is generated, the edited content may be approved for transmission to the target recipient or automatically transmitted to the target recipient.

In some implementations, the processing device receives feedback on the edited content from the target recipient, which may be in the form of words, sentences, or phrases by the target recipient or the existence or non-existence of interactive events (e.g., a click-through event may be indicative of a positive response, while a failure to open an email may be indicative of a negative response). In some implementations, the processing device updates data stored in the profile associated with the target recipient (e.g., profile data 422 and historical interaction data 426). The updated data may be further processed to update an AI model (e.g., AI training data 432) and natural language data (e.g., natural language data 434).

In one implementation, a computer-implemented method comprises: receiving proposed content (e.g., a proposed email, a proposed instant message, a proposed text message, etc.) to be transmitted to a target recipient; computing semantic factors descriptive of the proposed content; identifying portions of the proposed content having associated semantic factors that fail to match preferred semantic factors stored in a profile associated with the target recipient; and generating recommended edits to the identified portions of the proposed content, wherein computed semantic factors of the recommended edits match the preferred semantic factors.

In one implementation, a computer-implemented method comprises: generating or identifying a proposed message to be sent to a target recipient by a chatbot; editing the proposed message based on a profile associated with the target recipient to generate an edited message; and transmitting the edited message to the target recipient.

In the foregoing description, numerous details are set forth. It will be apparent, however, to one of ordinary skill in the art having the benefit of this disclosure, that the present disclosure may be practiced without these specific details. While specific implementations have been described herein, it should be understood that they have been presented by way of example only, and not limitation. The breadth and scope of the present application should not be limited by any of the implementations described herein, but should be defined only in accordance with the following and later-submitted claims and their equivalents. Indeed, other various implementations of and modifications to the present disclosure, in addition to those described herein, will be apparent to those of ordinary skill in the art from the foregoing description and accompanying drawings. Thus, such other implementations and modifications are intended to fall within the scope of the present disclosure.

Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

What is claimed is:

1. A computer-implemented method comprising:
receiving proposed content to be transmitted to a target recipient;
computing a semantic factor descriptive of the proposed content;
comparing the semantic factor with data stored in a profile associated with the target recipient; and
generating, based on the comparison, a recommended edit to the proposed content to customize the proposed content to the target recipient.

2. The computer-implemented method of claim 1, wherein the semantic factor is representative of a tone, style, grade level, or complexity of the proposed content.

3. The computer-implemented method of claim 1, wherein the target recipient is an individual recipient, a group of individual recipients, or an audience, and wherein the profile comprises information indicative of preferred semantic factors for the individual recipient, the group of individual recipients, or the audience.

4. The computer-implemented method of claim 1, wherein comparing the semantic factor with data stored in the profile associated with the target recipient comprises identifying one or more portions of the proposed content that fail to match a preferred semantic factor of the target recipient.

5. The computer-implemented method of claim 1, wherein generating, based on the comparison, the recommended edit to the proposed content comprises generating the recommended edit based on language derived from a historical interaction with the target recipient.

6. The computer-implemented method of claim 5, further comprising:
identifying the historical interaction based on success metrics of historical interactions with the target recipient.

7. The computer-implemented method of claim 1, further comprising:
applying the recommended edit to the proposed content to generate edited content;
transmitting the edited content to the target recipient;
receiving feedback on the edited content from the target recipient; and
updating the data stored in a profile associated with the target recipient based on the feedback.

8. A database system comprising:
a processing device; and
a memory device coupled to the processing device, the memory device having instructions stored thereon that, in response to execution by the processing device, cause the processing device to:
receive proposed content to be transmitted to a target recipient;
compute a semantic factor descriptive of the proposed content;
compare the semantic factor with data stored in a profile associated with the target recipient; and
generate, based on the comparison, a recommended edit to the proposed content to customize the proposed content to the target recipient.

9. The database system of claim 8, wherein the semantic factor is representative of a tone, style, grade level, or complexity of the proposed content.

10. The database system of claim 8, wherein the target recipient is an individual recipient, a group of individual recipients, or an audience, and wherein the profile comprises information indicative of preferred semantic factors for the individual recipient, the group of individual recipients, or the audience.

11. The database system of claim 8, wherein to compare the semantic factor with data stored in the profile associated with the target recipient, the processing device is to further identify one or more portions of the proposed content that fail to match a preferred semantic factor of the target recipient.

12. The database system of claim 8, wherein to generate, based on the comparison, the recommended edit to the proposed content, the processing device is to further generate the recommended edit based on language derived from a historical interaction with the target recipient.

13. The database system of claim 12, wherein the processing device is to further:
identify the historical interaction based on success metrics of historical interactions with the target recipient.

14. The database system of claim 8, wherein the processing device is to further:
apply the recommended edit to the proposed content to generate edited content;
transmit the edited content to the target recipient;
receive feedback on the edited content from the target recipient; and
update the data stored in a profile associated with the target recipient based on the feedback.

15. A non-transitory computer-readable storage medium having instructions encoded thereon which, when executed by a processing device, cause the processing device to:
receive proposed content to be transmitted to a target recipient;
compute a semantic factor descriptive of the proposed content;
compare the semantic factor with data stored in a profile associated with the target recipient; and
generate, based on the comparison, a recommended edit to the proposed content to customize the proposed content to the target recipient.

16. The non-transitory computer-readable storage medium of claim 15, wherein the semantic factor is representative of a tone, style, grade level, or complexity of the proposed content.

17. The non-transitory computer-readable storage medium of claim 15, wherein the target recipient is an individual recipient, a group of individual recipients, or an audience, and wherein the profile comprises information indicative of preferred semantic factors for the individual recipient, the group of individual recipients, or the audience.

18. The non-transitory computer-readable storage medium of claim 15, wherein to compare the semantic factor with data stored in the profile associated with the target recipient, the processing device is to further identify one or more portions of the proposed content that fail to match a preferred semantic factor of the target recipient.

19. The non-transitory computer-readable storage medium of claim 15, wherein to generate, based on the comparison, the recommended edit to the proposed content, the processing device is to further:
generate the recommended edit based on language derived from a historical interaction with the target recipient; and
identify the historical interaction based on success metrics of historical interactions with the target recipient.

20. The non-transitory computer-readable storage medium of claim 15, wherein the processing device is to further:
apply the recommended edit to the proposed content to generate edited content;
transmit the edited content to the target recipient;
receive feedback on the edited content from the target recipient; and
update the data stored in a profile associated with the target recipient based on the feedback.
